(19) United States
(12) Patent Application Publication
(10) Pub. No.: US 2023/0230176 A1
(43) Pub. Date: Jul. 20, 2023

(54) SYSTEMS AND METHODS FOR DETECTING DUPLICATE CHECKS

(71) Applicant: Change Healthcare Holdings, LLC, Nastiville, TN (US)

(72) Inventor: Ram Neelakantan, St. Louis, MO (US)

(21) Appl. No.: 17/575,794

(22) Filed: Jan. 14, 2022

(51) Int. Cl. G06Q 40/00; G06Q 10/10

(52) U.S. Cl. CPC G06Q 40/128; G06Q 10/10

(57) ABSTRACT

In an embodiment, a system for preventing the mailing of duplicate checks is provided. When payment information is received for a check, a code is generated. The code may identify the payment and may be based on the payment information. When the check is composed for the payment, the code is included such that when the check is printed, the code is printed on the check. After the check is printed and sent to the inserter for insertion into an envelope, the inserter reads the code on the check. The inserter compares the code to a list of previously scanned codes. If the inserter finds the code on the list, then the check is a duplicate check and can be prevented from being mailed. If the code is not one the list, then the inserter adds the code to the list, and allows the check to be mailed.

### BACKGROUND

For payment processors, check duplication is an ongoing problem. When information for a payment is received, a payment processor typically generates and mails a check corresponding to the received payment information. For various reasons, under some circumstances, multiple duplicate checks may be generated and mailed for the same payment. As may be appreciated, such check duplication may cause confusion for the payee upon receiving multiple checks and may cause financial issues for the payor if multiple copies of the same check are cashed or deposited.

### SUMMARY

In an embodiment, a system for preventing the mailing of duplicate checks is provided. When payment information is received for a check, a code is generated. The code may uniquely identify the check. When the check is composed for the payment, the code is included on the check such that when the check is printed, the code is also printed on the check. Later, after the check is printed and sent to the inserter for insertion into an envelope, the inserter reads the code on the check as it is placed into the envelope for mailing. The inserter compares the code to a list or database of previously scanned codes. If the inserter finds the code on the list, then the check is a duplicate check and can be discarded or otherwise prevented from being mailed. If the code is not on the list, then the inserter adds the code to the list, but otherwise allows the check to be mailed.

In an embodiment, a method is provided. The method includes: receiving information for a payment by a first computing device; generating a code based on the received information for the payment by the first computing device; composing a check by the computing device based on the received information for the payment by the first computing device, wherein the check includes the code; causing the composed check to be printed by the first computing device, wherein the printed check includes the code; receiving the printed check by a second computing device; reading the code on the printed check by the second computing device; determining that the printed check is a duplicate check based on the code by the second computing device; and in response to determining that the printed check is a duplicate check, preventing the printed check from being mailed by the second computing device.

Embodiments may include some or all of the following features. The second computing device may be an inserter. The code may be a barcode or a QR code. Determining that the printed check is a duplicate check based on the code may include: searching for the code in a code database; and determining that the printed check is a duplicate check if the code is found in the code database. Preventing the printed check from being mailed may include one or more of alerting an administrator, preventing the printed check from being inserted into an envelope, marking the check or envelope, and destroying the check or envelope. The method may further include: determining that the check is not a duplicate check based on the code; and in response to the determination that the check is not a duplicate check, adding the code to a code database. The information for the payment may include a payee, a payor, and an amount.

In an embodiment, a system is provided. The system may include: a code database; and a first computing device adapted to: receive a printed check, wherein the printed check includes a code; read the code on the printed check; determine if the code is in the code database; and if it is determined that the code is in the code database, prevent the printed check from being mailed.

Embodiments may include some or all of the following features. The first computing device may be further adapted to: if it is determined that the code is not in the code database, add the code to the code database. The first computing device may be an inserter. The code may be a barcode or a QR code. Preventing the printed check from being mailed may include one or more of alerting an administrator, preventing the printed check from being inserted into an envelope, marking the check or envelope, and destroying the check or envelope. The system may further include a second computing device adapted to: receive information for a payment; generate the code based on the received information for the payment; compose a check by the based on the received information for the payment, wherein the check includes the code; cause the composed check to be printed, wherein the printed check includes the code; and send the printed check to the first computing device.

In an embodiment, a non-transitory computer-readable medium is provided. The non-transitory computer-readable medium has computer-executable instructions stored thereon that when executed by at least one computing device cause the at least one computing device to: receive information for a payment; generate a code based on the received information for the payment; compose a check based on the received information for the payment, wherein the check includes the code; cause the composed check to be printed, wherein the printed check includes the code; receive the printed check; read the code on the printed check; determine that the printed check is a duplicate check based on the code; and in response to determining that the printed check is a duplicate check, prevent the printed check from being mailed.

Embodiments may include some or all of the following features. The at least one computing device may be an inserter. The code may be a barcode or a QR code. Determining that the printed check is a duplicate check based on the code may include: searching for the code in a code database; and determining that the printed check is a duplicate check if the code is found in the code database. Preventing the printed check from being mailed may include one or more of alerting an administrator, preventing the printed check from being inserted into an envelope, marking the check or envelope, and destroying the check or envelope. The information for the payment may include a payee, a payor, and an amount.

The systems and methods described herein provide the following advantages. First, preventing the mailing of duplicate checks could potentially save payors millions of dollars. Second, the step of check insertion, where the check is placed in the envelope, is the last possible step in a check mailing pipeline where a duplicate check could be identified before being mailed. Accordingly, identifying duplicate checks at the inserter may identify duplicate checks that were missed by other check duplication prevention measures taken earlier in the pipeline.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a check duplication prevention system and method. Together with the description, the figures further serve to explain the principles of the check duplication prevention system and method described herein and thereby enable a person skilled in the pertinent art to make and use the check duplication prevention system and method.

FIG. 1 is an example environment for printing and mailing checks and for preventing check duplication;

FIG. 2 is an illustration of an example method for generating a code for a check to prevent check duplication;

FIG. 3 is an illustration of an example method for preventing duplicate checks; and

FIG. 4 shows an exemplary computing environment in which example embodiments and aspects may be implemented.

### DETAILED DESCRIPTION

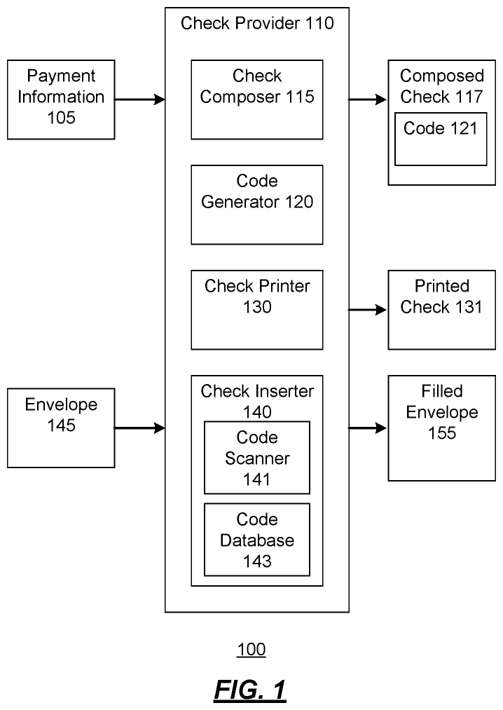

FIG. 1 is an example environment for printing and mailing checks and for preventing check duplication. As shown, the environment 100 may include a check provider 110. The check provider 110 may receive payment information 105 and may generate and send one or more checks corresponding to the payment information 105. Depending on the embodiment, the payment information 105 may identify a payor, a payee, an amount of the payment, and a date when the check should be mailed by. In some embodiments, the payment information 105 may further identify a matter, item, or claim that is related to the payment.

In some embodiments, the check provider 110 may be part of a medical claims clearinghouse, and the payment information 105 may relate to a payment from an insurance company payor to one or more medical providers. The payments may be for services provided by the medical providers on behalf of customers or policy holders of the insurance companies. As may be appreciated, each payment may represent payment for a batch of services provided by the medical providers. Note that the check provider 110 is not limited to medical claims clearinghouses but can be used by any entity that routinely generates and mails checks to clients, customers, or other entities.

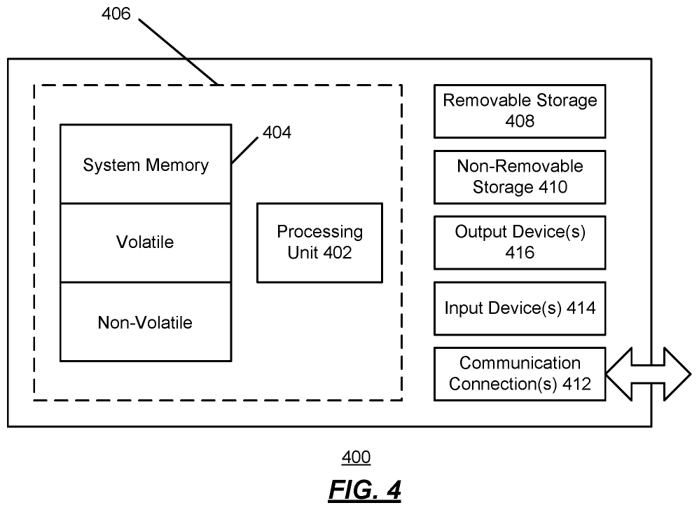

In order to prevent or reduce the number of duplicate checks, the check provider 110 may include several components including, but not limited to, a check composer 115, a code generator 120, a check printer 130, and a check inserter 140. More or fewer components may be supported. Each component may be implemented together or separately using one or more general purpose computing devices such as the computing device 400 illustrated with respect to FIG. 4.

The check composer 115 may receive payment information 105 and may compose a check 117 corresponding to the payment information 105. Depending on the embodiment, the composed check 117 may be a digital representation of a physical check and may include all of the information typically associated with a check such as a payor, payee, amount, date, signature, and check number. The check 117 may further identify an account number and/or bank that that check is drawn from. Any method for generating or composing a check 117 may be used. After generating the composed check 117 the check composer 115 may store the composed check 117 where it may wait to be printed by the check printer 130.

The code generator 120 may generate and assign a code 121 to each composed check 117. The code 121 may be a bar code, QR code, or any other type of machine readable code. The code 121 may be based on the payment information 105 and/or the information associated with the check such as the check number, date, payor, payee, and payment amount. Each code 121 may uniquely identify a composed check 117.

The code generator 120 may associate the code 121 with the composed check 117 such that when the composed check 117 is printed, the code 121 is also printed on the check 117. Where the composed check 117 is stored as a graphics file or image, the code generator 120 may write or draw the code 121 into the stored graphics file or image. The code 121 may be printed on the check 117 at a standard location on the check 117. For example, the code 121 may be a 3 of 9 barcode that is printed at a known location on the check 117 such as near the memo line or above the signature line. Other locations may be selected for the code 121.

The check printer 130 may print the composed check 117 including the associated code 121. Depending on the embodiment, the check printer 130 may print a composed check 117 including the code 121 when received from the code generator 120. Alternatively, the check printer 130 may print the composed check 117 including the code 121 at or around a payment date associated with the payment information 105 and/or the composed check 117. The printed composed check 117 with the code 121 is referred to herein as the printed check 131.

Depending on the embodiment, the check printer 130 may also facilitate the printing of an envelope 145 for each printed check 131. Each envelope 145 may be addressed to a payee associated with the printed check 131 and/or the payment information 105.

The check inserter 140 may insert printed checks 131 into their corresponding envelope 145. An envelope 145 with an inserted printed check 131 is referred to herein as a filled envelope 155. Any type of document inserter may be used.

The check inserter 140, to facilitate the detection of duplicate printed checks 131, may further include a code scanner 141 and a code database 143. Other components may be supported.

The code scanner 141 may be an optical device such as a camera or barcode scanner that is capable of reading the code 121 printed on each printed check 131. Depending on the embodiment, the code 121 on a printed check 131 may be read by the code scanner 141 as the printed check 131 is inserted into envelope 145. Alternatively, the code 121 on the printed check 131 may be read by the code scanner 141 before the printed check 131 is inserted into the envelope 145. The code scanner 141 may be added to an existing inserter 140 as a modification or may be a reuse or repurposing of an existing scanner or camera of the inserter 140.

The code database 143 may be a database of codes 121 that have been seen or read by the code scanner 141 of the check inserter 140. Other types of data structures such as lists or trees may be used for the code database 143.

Depending on the embodiment, when a code 121 is read by the code scanner 141 from a printed check 131 that is inserted into an envelope 145 by the check inserter 140, the check inserter 140 may add the code 121 to the code database 143. The code database 143 may be stored in a memory of the check inserter 140 so that it can be accessed quickly by the check inserter 140. Where multiple check inserters 140 are used, the code database 143 may be shared by the check inserters 140 in a shared memory or network location.

To prevent duplicate printed checks 131, during the check insertion process, after the code scanner 141 reads the code 121 on the printed check 131, the check inserter 140 may search the code database 143 for the code 121. If the check inserter 140 finds the code 121 in the code database 143, then the printed check 131 has already been mailed, and therefore the printed check 131 should be stopped or otherwise prevented from being mailed. If the check inserter 140 does not find the code 121 in the database 143, the printed check 131 has not been mailed, and the filled envelope 155 should be mailed. In addition, to prevent a duplicate printed check 131 from being mailed, the check inserter 140 may add the code 121 to the code database 143.

When the check inserter 140 determines that the printed check 131 is a duplicate check, the check inserter 140 may take several actions. In embodiments where the check inserter 140 reads the code 121 before inserting the printed check 131 into the envelope 145, upon determining that the check 131 is a duplicate, the check inserter 140 may discard the printed check 131 or may otherwise prevent the printed check 131 from being inserted into the envelope 145. In addition, the check inserter 140 may mark one or both of the printed check 131 and the envelope 145 to indicate that the check 131 is a duplicate check 131 and may alert a user or administrator regarding the duplicate check 131.

In embodiments where the check inserter 140 reads the code 121 while inserting the printed check 131 into the envelope 145, upon determining that the check 131 is a duplicate, the check inserter 140 may cause the filled envelope 155 to be discarded or removed from processing. In addition, the check inserter 140 may mark the filled envelope 155 to indicate that the filled envelope 155 should be destroyed and may alert a user or administrator regarding the duplicate check 131 in the filled envelope 155.

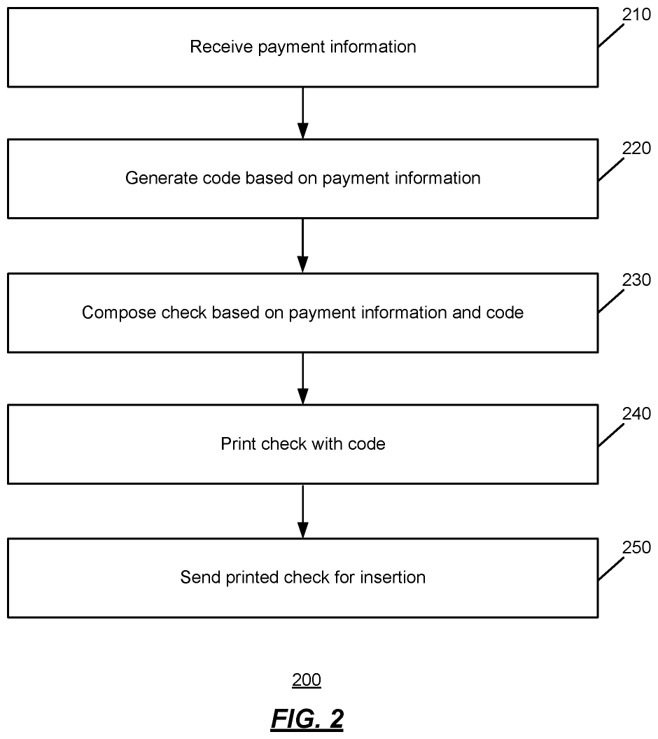

FIG. 2 is an illustration of an example method 200 for generating a code for a check to prevent check duplication. The method 200 may be implemented by the check provider 110.

At 210, payment information is received. The payment information 105 may be received by the check composer 115. The payment information 105 may include information such as a payor, a payee, a payment amount, and a payment date. The payment information 105 may further indicate an invoice number or claim number, or claim numbers, that the associated payment is being made in relation to.

At 220, a code is generated based on the payment information. The code 121 may be generated by the code generator 120. The code 121 may be a barcode or a QR code and may uniquely identify a check that will be issued that corresponds to the payment information 105. The code 121 may encode some or all of the payment information 105 and may uniquely identify the check. Any method for generating a code 121 may be used.

At 230, a check is composed based on the payment information and the code. The check may be composed by the check composer 115. The composed check 117 may be an image or graphic file and may include the code 121. The code 121 may be in a particular location on the composed check 117 that will be readable by the inserter.

At 240, the composed check is printed with the code. The composed check 117 may be printed with the code 121 to create the printed check 131. Any method or technique for printing a code 121 and a check may be used.

At 250, the printed check is sent for insertion. The printed check 131 may be sent to an inserter 140 for insertion into an envelope 145. The envelope 145 may have been similarly printed based on the payment information 105.

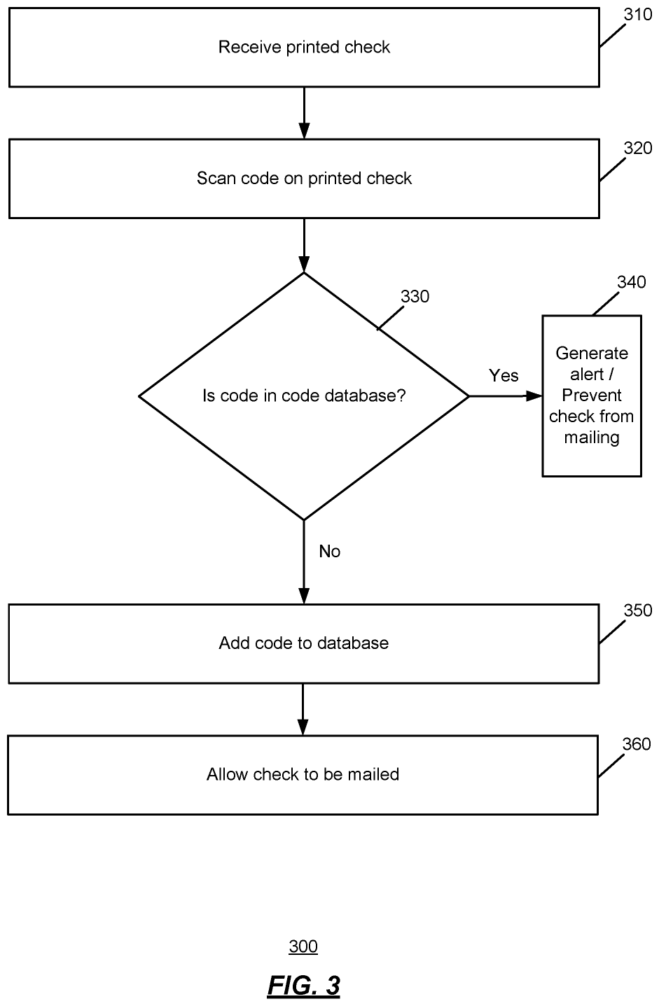

FIG. 3 is an illustration of an example method for preventing duplicate checks. The method 300 may be implemented by the check provider 110.

At 310, a printed check is received. The printed check 131 may be received by the check inserter 140 from the check printer 130.

At 320, the code on the printed check is scanned. The code 121 may be scanned by the code scanner 141 of the check inserter 140. Depending on the embodiment, the code scanner 141 may scan (or otherwise capture) the code 121 as the printed check 131 is inserted into the corresponding envelope 145, or before the printed check 131 is inserted into the corresponding envelope 145.

At 330, whether the code is in the code database is determined. Whether the code 121 is in the code database 143 is determined by the check inserter 140. If the code 121 is in the code database 143 then the printed check is a duplicate check and the method 300 may continue at 340. If the code 121 is not in the code database 143 then the printed check 131 is not a duplicate check and the method 300 may continue at 350.

At 340, the check is prevented from being mailed. The printed check 131 may be prevented from being mailed by the check inserter 140. Where the check 131 was already inserted into the envelope 145, the filled envelope 155 may be marked or diverted so that it is not mailed. Where the check 131 was not yet inserted into the envelope 145, the inserter 140 may discard the check 131 or may otherwise mark the check 131 so that it cannot be mailed or cashed. In either embodiment, a user or administrator may be alerted about the duplicate check.

At 350, the code is added to the database. The code 121 may be added to the code database 143 by the check inserter 140. Adding the code 121 to the code database 143 may prevent a duplicate of the printed check 131 from being mailed by the check inserter should a duplicate check with the same code 121 be received by the inserter 140 (or a different inserter 140).

At 360, the check is allowed to be mailed. The printed check 131 in the filled envelope 155 may be allowed to be mailed by the check provider 110.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving information for a payment by a first computing device;
generating a code based on the received information for the payment by the first computing device;
composing a check by the computing device based on the received information for the payment by the first computing device, wherein the check includes the code;
causing the composed check to be printed by the first computing device, wherein the printed check includes the code;
receiving the printed check by a second computing device;
reading the code on the printed check by the second computing device;
determining that the printed check is a duplicate check based on the code by the second computing device; and
in response to determining that the printed check is a duplicate check, preventing the printed check from being mailed by the second computing device.

2. The method of claim 1, wherein the second computing device is an inserter.

3. The method of claim 1, wherein the code is a barcode or a QR code.

4. The method of claim 1, wherein determining that the printed check is a duplicate check based on the code comprises:
searching for the code in a code database; and
determining that the printed check is a duplicate check if the code is found in the code database.

5. The method of claim 1, wherein preventing the printed check from being mailed comprises one or more of alerting an administrator, preventing the printed check from being inserted into an envelope, marking the check or envelope, and destroying the check or envelope.

6. The method of claim 1, further comprising:
determining that the check is not a duplicate check based on the code; and
in response to the determination that the check is not a duplicate check, adding the code to a code database.

7. The method of claim 1, wherein the information for the payment comprises a payee, a payor, and an amount.

8. A system comprising:
a code database; and
a first computing device adapted to:
receive a printed check, wherein the printed check includes a code;
read the code on the printed check;
determine if the code is in the code database; and
if it is determined that the code is in the code database, prevent the printed check from being mailed.

9. The system of claim 8, wherein the first computing device is further adapted to:
if it is determined that the code is not in the code database, add the code to the code database.

10. The system of claim 8, wherein the first computing device is an inserter.

11. The system of claim 8, wherein the code is a barcode or a QR code.

12. The system of claim 8, wherein preventing the printed check from being mailed comprises one or more of alerting an administrator, preventing the printed check from being inserted into an envelope, marking the check or envelope, and destroying the check or envelope.

13. The system of claim 8 further comprising a second computing device adapted to:
receive information for a payment;
generate the code based on the received information for the payment;
compose a check by the based on the received information for the payment, wherein the check includes the code;
cause the composed check to be printed, wherein the printed check includes the code; and
send the printed check to the first computing device.

14. A non-transitory computer-readable medium with computer-executable instructions stored thereon that when executed by at least one computing device cause the at least one computing device to:
receive information for a payment;
generate a code based on the received information for the payment;
compose a check based on the received information for the payment, wherein the check includes the code;
cause the composed check to be printed, wherein the printed check includes the code;
receive the printed check;
read the code on the printed check;
determine that the printed check is a duplicate check based on the code; and
in response to determining that the printed check is a duplicate check, prevent the printed check from being mailed.

15. The non-transitory computer-readable medium of claim 14, wherein the at least one computing device is an inserter.

16. The non-transitory computer-readable medium of claim 14, wherein the code is a barcode or a QR code.

17. The non-transitory computer-readable medium of claim 14, wherein determining that the printed check is a duplicate check based on the code comprises:
searching for the code in a code database; and
determining that the printed check is a duplicate check if the code is found in the code database.

18. The non-transitory computer-readable medium of claim 14, wherein preventing the printed check from being mailed comprises one or more of alerting an administrator, preventing the printed check from being inserted into an envelope, marking the check or envelope, and destroying the check or envelope.

19. The non-transitory computer-readable medium of claim 14, further comprising:
determining that the check is not a duplicate check based on the code; and
in response to the determination that the check is not a duplicate check, adding the code to a code database.

20. The non-transitory computer-readable medium of claim 14, wherein the information for the payment comprises a payee, a payor, and an amount.
